(19) United States
(12) Patent Application Publication
(10) Pub. No.: US 2024/0419503 A1
(43) Pub. Date: Dec. 19, 2024

(54) RECOMMENDATION OF WORKLOAD ALLOCATION POLICIES FOR MULTI-ACCESS EDGE COMPUTING

(71) Applicant: INTERNATIONAL BUSINESS MACHINES CORPORATION, Armonk, NY (US)

(72) Inventor: Kaustabha Ray, Bangalore (IN)

(21) Appl. No.: 18/336,730

(22) Filed: Jun. 16, 2023

(51) Int. Cl. G06F 9/50; G06F 9/445; G06N 7/01

(52) U.S. Cl. CPC G06F 9/505; G06F 9/44526; G06N 7/01

(57) ABSTRACT

Provided are a method, system, and computer program product in which a plurality of edge computing nodes are provided in a multi-access edge computing environment. Workload allocation policies are recommended in the multi-access edge computing environment by determining which policy to use to allocate workloads to edge sites to maximize the probability of carbon footprint requirements being satisfied given the uncertainty with observability data.

### BACKGROUND

Embodiments relate to a method, system, and computer program product for the recommendation of workload allocation policies in Multi-Access Edge Computing.

Multi-Access Edge Computing (MEC) is used as an application service provisioning paradigm for low-latency access to services in a cellular telephony network. In MEC paradigms, service providers deploy their application services on MEC servers adjacent to mobile base stations. Computationally intensive operations from Internet-of-Things (IoT) devices may be directed to nearby MEC servers as the IoT devices move around, in order to reduce latency in comparison to accessing services located at traditional cloud data centers.

Carbon footprint is an amount of gaseous emissions that are relevant to climate change and associated with human production or consumption activities. In certain situations, the carbon footprint is expressed as the carbon dioxide equivalent which is meant to sum up the total greenhouse gas emissions caused by an individual, event, organization, service, place, or product. In other cases, only the carbon dioxide emissions are taken into account but not those of other greenhouse gases.

U.S. Pat. No. 8,359,598B2 discusses an energy efficient scheduling system and method. CN102722235B discusses a carbon footprint-reduced server resource integrating method. US20150227397A1 discusses energy efficient assignment of workloads in a datacenter.

### SUMMARY

Provided are a method, system, and computer program product in which a plurality of edge computing nodes are provided in a multi-access edge computing environment. Workload allocation policies are recommended in the multi-access edge computing environment by determining which policy to use to allocate workloads to edge sites to maximize a probability of carbon footprint requirements being satisfied given an uncertainty with observability data.

In further embodiments, operations that act as a plugin to existing orchestration platforms for allocation policy recommendation are performed by quantifying a risk associated with uncertainty metrics gathered from the observability data.

In other embodiments, workload allocation policies are modeled as Probabilistic Timed Automata.

In additional embodiments, freshness of observability data is modeled by using clocks of a Probabilistic Timed Automata.

In certain embodiments, operations model carbon-footprint metric as labels of a Probabilistic Timed Automata and variations in user workloads as probability distributions.

In additional embodiments, entities represent policies as probabilistic transitions determined from historical execution of policy execution logs.

In yet additional embodiments, Probabilistic Timed Automata models with a Probabilistic Model Checker are utilized to determine a probability of an allocation policy's adherence to a carbon-footprint metric.

### BRIEF DESCRIPTION OF THE DRAWINGS

Referring now to the drawings in which like reference numbers represent corresponding parts throughout:

FIG. 1 illustrates a block diagram of a multi-access edge computing environment, in accordance with certain embodiments.

FIG. 2 illustrates a first block diagram for workload allocation based on carbon emissions, in accordance with certain embodiments.

FIG. 3 illustrates a second block diagram for workload allocation based on carbon emissions, in accordance with certain embodiments.

FIG. 4 illustrates a third block diagram of workload allocation based on carbon emissions, in accordance with certain embodiments.

FIG. 5 illustrates a block diagram of characteristics of certain embodiments and policies addressed, in accordance with certain embodiments.

FIG. 6 illustrates a block diagram that provides an exemplary embodiment for policy recommendation, in accordance with certain embodiments.

FIG. 7 illustrates a block diagram that shows characteristics of labeled probabilistic timed automata of edge sites, and model descriptions, in accordance with certain embodiments.

FIG. 8 illustrates a block diagram that shows the quantifying of freshness of observability data, in accordance with certain embodiments.

FIG. 9 illustrates a block diagram that shows probabilistic time automata models for risk assessment, in accordance with certain embodiments.

FIG. 10 illustrates a block diagram that shows policy rank determination in accordance with certain embodiments.

FIG. 11 illustrates a flowchart for recommendation of workload allocation policies in multi-access edge computing, in accordance with certain embodiments.

FIG. 12 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made. Several examples will now be provided to further clarify various embodiments of the present disclosure:

Example 1: A method in which a plurality of edge computing nodes are provided in a multi-access edge computing environment. Workload allocation policies are recommended in the multi-access edge computing environment by determining which policy to use to allocate workloads to edge sites to maximize a probability of carbon footprint requirements being satisfied given an uncertainty with observability data. As a result, carbon footprint requirements are reduced in a multi-access edge computing environment and performance improvements are made in the operations of computing systems.

Example 2: The limitations of any of Examples 1 and 3-7, where operations that act as a plugin to existing orchestration platforms for allocation policy recommendation are performed by quantifying a risk associated with uncertainty metrics gathered from the observability data. As a result, risk associated with uncertainty metrics are utilized to provide improvements in the reduction of carbon footprints in a multi-access edge computing environment.

Example 3: The limitations of any of Examples 1-2 and 4-7, where workload allocation policies are modeled as Probabilistic Timed Automata. As a result, workload allocation policies are utilized to provide improvements in the reduction of carbon footprints in a multi-access edge computing environment.

Example 4: The limitations of any of Examples 1-3 and 5-7, where freshness of observability data is modeled by using clocks of a Probabilistic Timed Automata. As a result, observability data is utilized to provide improvements in the reduction of carbon footprints in a multi-access edge computing environment.

Example 5: The limitations of any of Examples 1-4 and 6-7, where operations model carbon-footprint metric as labels of a Probabilistic Timed Automata and variations in user workloads as probability distributions. As a result, Probabilistic Timed Automata is utilized to provide improvements in the reduction of carbon footprints in a multi-access edge computing environment.

Example 6: The limitations of any of Examples 1-5 and 7, where entities represent policies as probabilistic transitions determined from historical execution of policy execution logs. As a result, execution policy logs are utilized to provide improvements in the reduction of carbon footprints in a multi-access edge computing environment.

Example 7: The limitations of any of Examples 1-6, where Probabilistic Timed Automata models with a Probabilistic Model Checker are utilized to determine a probability of an allocation policy's adherence to a carbon-footprint metric. As a result, a Probability Model Checker is utilized to provide improvements in the reduction of carbon footprints in a multi-access edge computing environment.

Example 8: A system, comprising a memory, and a processor coupled to the memory, where the processor performs operations, the operations comprising performing a method according to any one of Examples 1-7. As a result, carbon footprint requirements are reduced in a multi-access edge computing environment and performance improvements are made in the operations of computing systems.

Example 9: A computer program product, the computer program product comprising a computer readable storage medium having computer readable program code embodied therewith, the computer readable program code when executed is configured to perform operations, the operations comprising performing a method according to any of Examples 1-7. As a result, carbon footprint requirements are reduced in a multi-access edge computing environment and performance improvements are made in the operations of computing systems.

Sustainable computing may require carbon footprint reduction, and such a reduction of carbon footprint is very important for providers of cloud services. Certain embodiments provide several policies that are designed to execute workloads at different edge sites to save carbon footprint. A policy may produce an allocation which is a mapping from workload request to edge site for execution. Additionally, the policy may also decide on the server mapping for the workload request. The policies may execute decisions via observability data. Given multiple policies, certain embodiments determine which policy to use when a request is to be allocated to an edge site to ensure maximum probability of adherence to carbon footprint.

Edge Sites comprise heterogeneous servers with different carbon footprint consumption. Edge Sites have variable workload patterns depending on the time of day. Observability data is laden with uncertainty: edge sites may not have up to date information about the state of other edge sites, for example due to network congestion, link failures, propagation delay.

Certain embodiments are directed towards a method, system, and computer program product for recommendation of workload allocation policies in multi-access edge computing.

Certain embodiments determine which policy to use to allocate workloads to edge sites to maximize the probability of carbon footprint requirements being satisfied given the uncertainty associated with observability data.

Certain embodiments provide a plugin to existing orchestration platforms for allocation policy recommendation by quantifying the risk associated with the uncertainty of metrics gathered from observability data.

Certain embodiments model workload allocation policies as Probabilistic Timed Automata (PTA). Certain additional embodiments model freshness of observability data using clocks of a Probabilistic Timed Automata.

The embodiments include operations wherein a system models carbon-footprint metric as labels of a Probabilistic Timed Automata and variations in user workloads as probability distributions. Certain embodiments include operations in which the system represents policies as probabilistic transitions determined from historical execution of policy execution logs. The embodiments may include operations in which the system utilizes the PTA models with a Probabilistic Model Checker to determine the probability of an allocation policy's adherence to a carbon-footprint metric.

Certain embodiments relate to a system, method, and computer program product for recommendation of workload allocation politics in multi-access edge computing management of service availability for multi-access edge computing for reduction of carbon footprint. As a result, performance improvements are made in the operations of computing systems and mobile networks while at the same time reducing carbon footprint.

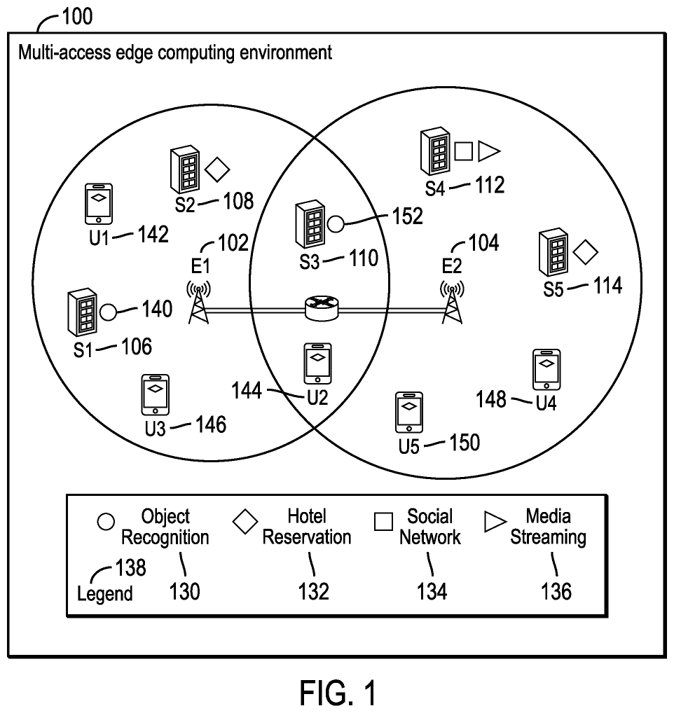

FIG. 1 illustrates a block diagram 100 of a multi-access edge computing environment, in accordance with certain embodiments.

Multiple edge sites comprising a first edge site E1 102 and a second edge site E2 104 are shown. Each edge site is comprised of a plurality of servers, where the servers are also referred to as edge servers. For example, the first edge site E1 102 is comprised of three servers S1, S2, S3 (shown via reference numerals 106, 108, 110) and the second edge site E2 104 is comprised of a server S4 and a server S5 (shown via reference numerals 112, 114).

Services are deployed on the edge servers. Exemplary services such as object recognition service 130, hotel reservation service 132, social network service 134, and media streaming service 136 are shown via the legend 138 at the bottom of FIG. 1. The service deployed on each server is shown. For example, in FIG. 1, server S1 106 has object recognition service 140 shown as running on the server S1. Devices U1, U2, U3, U4, U5 are shown in FIG. 1 (reference numerals 142, 144, 146, 148, 150). The devices U1, U2, U3, U4, U5 (reference numerals 142, 144, 146, 148, 150) may comprise user equipment such as mobile phones that request services deployed on the edge servers S1, S2, S3, S4, S5 (reference numerals 106, 108, 110, 112, 114).

Orchestration platforms such as Kubernetes© (Kubernetes is a trademark of “The Linux Foundation”) are used in certain embodiments. An orchestration platform includes one or more applications that may manage workloads and services in one or more edge sites. There is an orchestration platform for every edge site. Each orchestration platform may include a load balancer and executes on at least one edge server. The orchestration platform for an edge site executes in a server in the edge site, where the server may be a centralized policy controller.

In certain embodiments, servers in FIG. 1 may comprise any suitable computational device including those presently known in the art, such as, a personal computer, a workstation, a mainframe, a hand held computer, a palm top computer, a head mounted computer, a telephony device, a network appliance, a blade computer, a processing device, a controller, etc. The elements shown in FIG. 1 may be in any suitable network, such as, a storage area network, a wide area network, the Internet, an intranet, etc., or in a cloud computing environment.

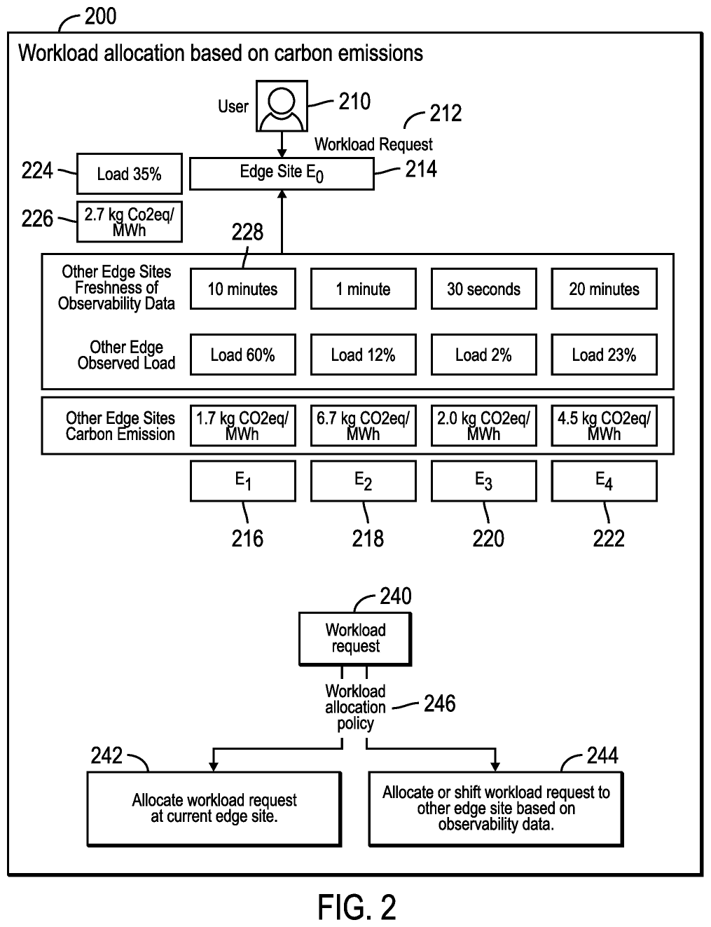

FIG. 2 illustrates a first block diagram 200 for workload allocation based on carbon emissions, in accordance with certain embodiments.

Motivating examples are provided that show uncertainty of observability data. A user 210 may make a workload request 212 to an edge site 214, where there are four other edge sites 216, 218, 220, 222.

Each edge site has a load associated with it. For example, edge site 214 has a load of 35% as shown by reference numeral 224. Each edge site also has a carbon footprint associated with it. For example, edge site 214 has a carbon footprint shown via reference numeral 226 where an example of carbon footprint is provided as 2.7 kg CO2 eq/MWh meaning 2.7 kilograms of Co2 equivalent is emitted per Megawatt hour for edge site 214.

Each edge size also has a freshness of observability data associated with it. The freshness of the observability data varies due to network congestion, link failures, propagation delay, etc. For example, the edge site 216 has a freshness of observability data of 10 minutes as shown via reference numeral 228.

When a workload request 240 is generated by a user, the workload may be allocated to a current edge site (shown via reference numeral 242) or may be allocated or shifted to other edge site based on the observability data (shown via reference numeral 244). Foe example, the workload request 212 may be allocated to edge size 214 or may be shifted to one of the other edge sites 216, 218, 220, 224. The allocation or shifting may be based on workload allocation policies (as shown via reference numeral 246).

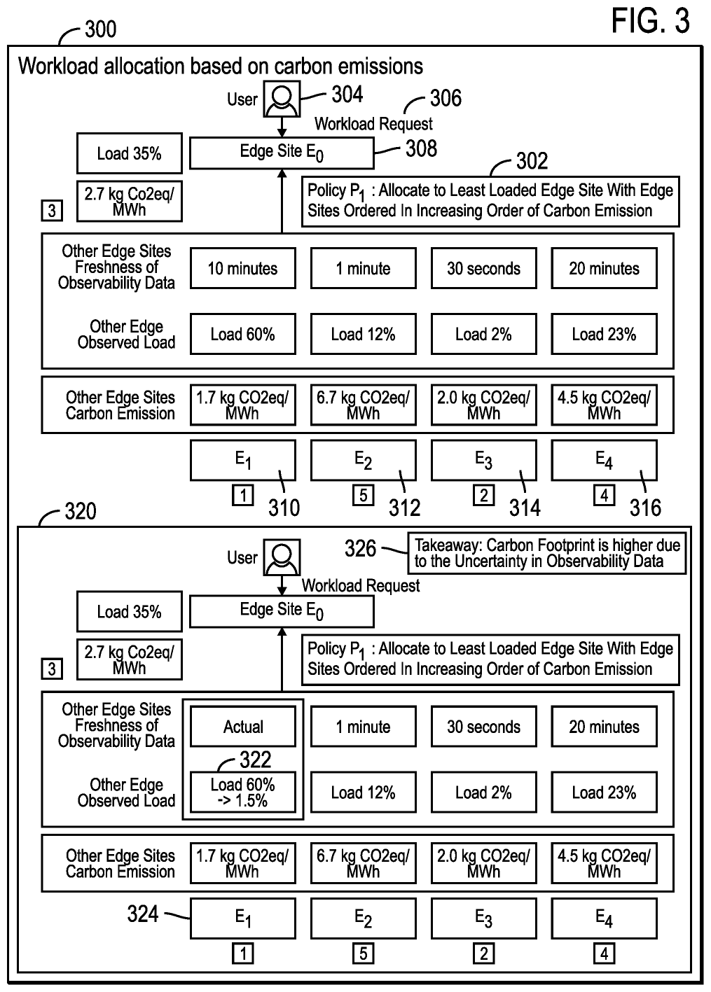

FIG. 3 illustrates a second block diagram 300 for workload allocation based on carbon emissions, in accordance with certain embodiments.

In FIG. 3, a workload allocation policy 302 is defined to allocate a workload request to the least loaded edge site with edge sites ordered in increasing order of carbon emission. A user 304 makes a workload request 306 to edge site 308.

Edge sites 310, 312, 314, 316 are ordered in increasing order of carbon emission. Since policy 302 is to allocate to least loaded edge site with edge sites ordered in increasing order of carbon emission, the workload request 306 is shifted to edge site 314 which has a load of 2% which is less than the load on the other ordered edge sites 310, 312, 316.

A problem is that the freshness of edge site 314 is 30 seconds, i.e., the 2% load is 30 seconds old data for edge site 314, and a freshness of edge site 310 is 10 minutes and edge site 310 has load 60% (edge site 310 is also labeled as E1).

However, block 320 shows that the actual load at the time of the shift is 1.5% and not 60% (shown via reference numeral 322) for edge site E1 (shown via reference numeral 324). When policy 302 is used, the carbon footprint is higher due to the uncertainty in observability data, the uncertainty being caused by the freshness of the load data (observability data) as shown via reference numeral 326.

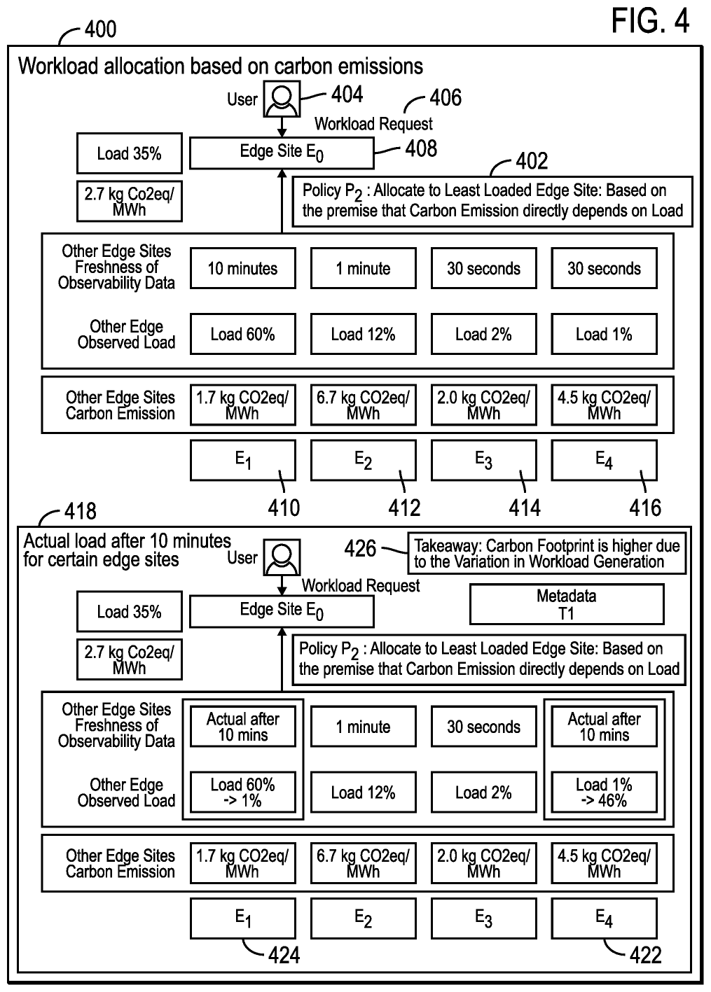

FIG. 4 illustrates a third block diagram 400 of workload allocation based on carbon emissions, in accordance with certain embodiments.

In FIG. 4, a workload allocation policy 402 is defined to allocate to least loaded edge site based on the premise that carbon emission directly depends on load. A user 404 makes a workload request 406 to edge site 408.

Since policy 402 is to allocate to least loaded edge site the workload request 406, and out of the edge sites 410, 412, 414, 416, edge site 416 is least loaded then the workload request 406 is shifted to edge site 416.

A problem is that the freshness of edge site 416 is 30 seconds, i.e., the 1% load is 30 seconds old data for edge site 416.

Block 418 shows the actual load after 10 minutes for certain edge sites. It can be seen that after 10 minutes edge site E4 422 has had its load changed from 1% to 46%, whereas edge site E1 424 has had its load changed from 60% to 1%. The carbon footprint is higher with the workload being allocated to E4 422. Therefore, because of stale freshness data of load (i.e., uncertainty in observability data) carbon footprint is higher due to the variation in workload generation. (shown via reference numeral 426).

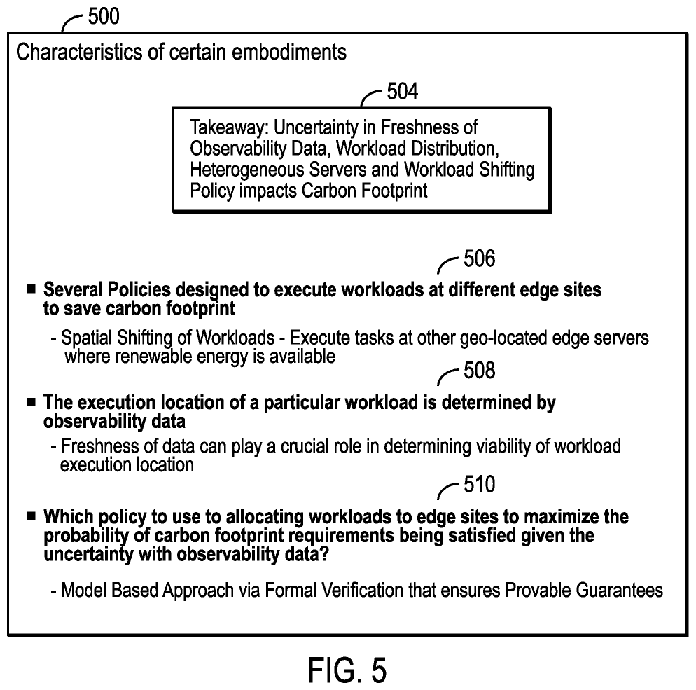

FIG. 5 illustrates a block diagram 500 of characteristics of certain embodiments and policies addressed, in accordance with certain embodiments.

It may be observed from FIGS. 2-4 that the uncertainty in freshness of observability data, workload distribution, heterogeneous servers, and workload shifting policy impacts carbon footprint (as shown via reference numeral 504).

Certain embodiments are provided to address a variety of problems. Several policies are designed to execute workloads at different edge sites to save carbon footprint (reference numeral 506). The spatial shifting of workloads may be used to execute tasks at other geo-located edge servers where renewable energy is available.

The execution location of a particular workload is determined by observability data. (reference numeral 508). Freshness of data can play a crucial role in determining viability of workload execution location.

Certain embodiments determine which policy to use to allocate workloads to edge sites to maximize the probability of carbon footprint requirements being satisfied given the uncertainty with observability data (reference numeral 510). A Model Based Approach via Formal Verification that ensures provable guarantees using probabilistic models may be used in certain embodiments.

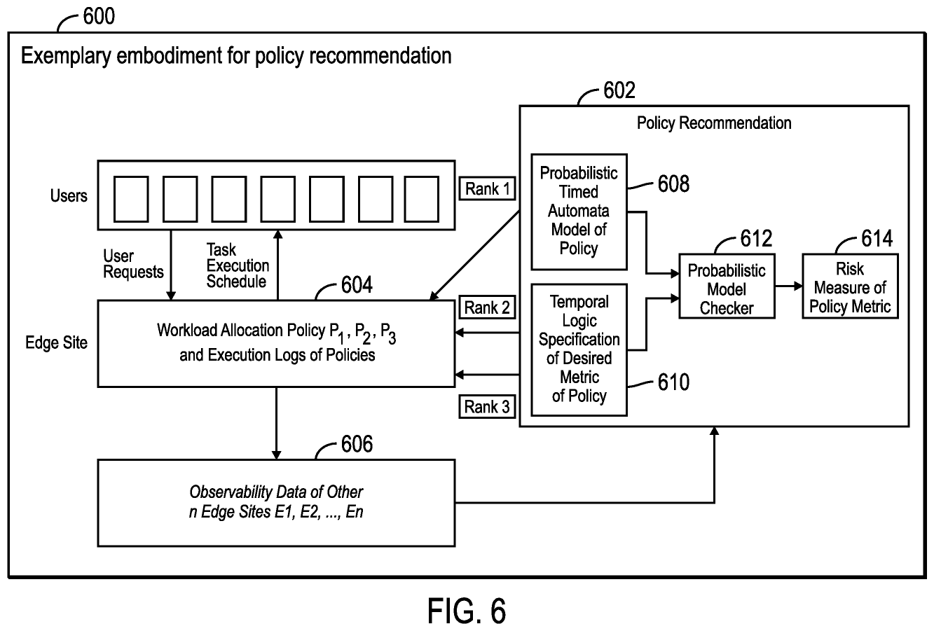

FIG. 6 illustrates a block diagram 600 that provides an exemplary embodiment for policy recommendation.

A policy recommendation engine 602 that interacts with workload allocation policies 604 and observability data 606 is used in certain embodiments. The policy recommendation engine uses a probabilistic timed automata model of policy 608 and a temporal logic specification of desired metric of policy 610 as inputs to a probabilistic model checker 612 to arrive at a risk measure of policy metric 614.

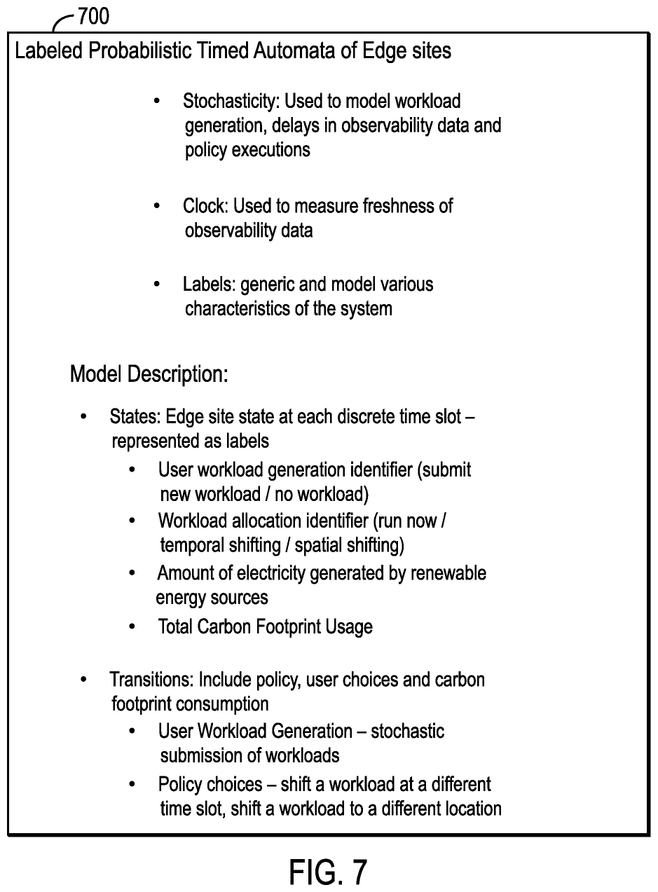

FIG. 7 illustrates a block diagram 700 that shows characteristics of labeled probabilistic timed automata of edge sites, and model descriptions, in accordance with certain embodiments.

Stochasticity is used to model workload generation, delays in observability data and policy executions. A clock is used to measure freshness of observability data. Labels are generic and model various characteristics of the system.

A model is constructed, and policy analyzed for each edge site where the model description includes states that denote edge site state at each discrete time slot (represented as labels). Various entities associated with this include:
1) User workload generation identifier (submit new workload/no workload);
2) Workload allocation identifier (run now/temporal shifting/spatial shifting);
3) Amount of electricity generated by renewable energy sources; and
4) Total Carbon Footprint Usage.

The transitions include policy, user choices and carbon footprint consumption. User Workload Generation is related to stochastic submission of workloads. Policy choices are related to shifting a workload at a different time slot, shift a workload to a different location, and so on.

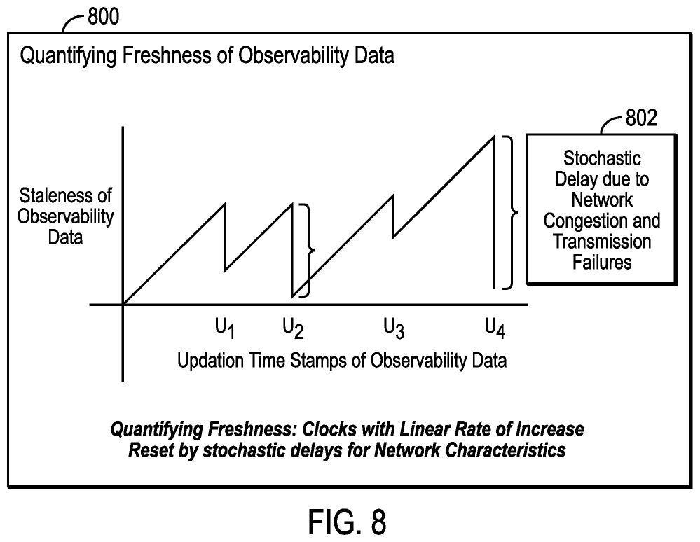

FIG. 8 illustrates a block diagram 800 that shows the quantifying of freshness of observability data, in accordance with certain embodiments. The X axis shows the updation time stamps of observability data and the Y axis the staleness of observability data. The stochastic delay due to network congestion and transmission failures are depicted (shown via reference numeral 802).

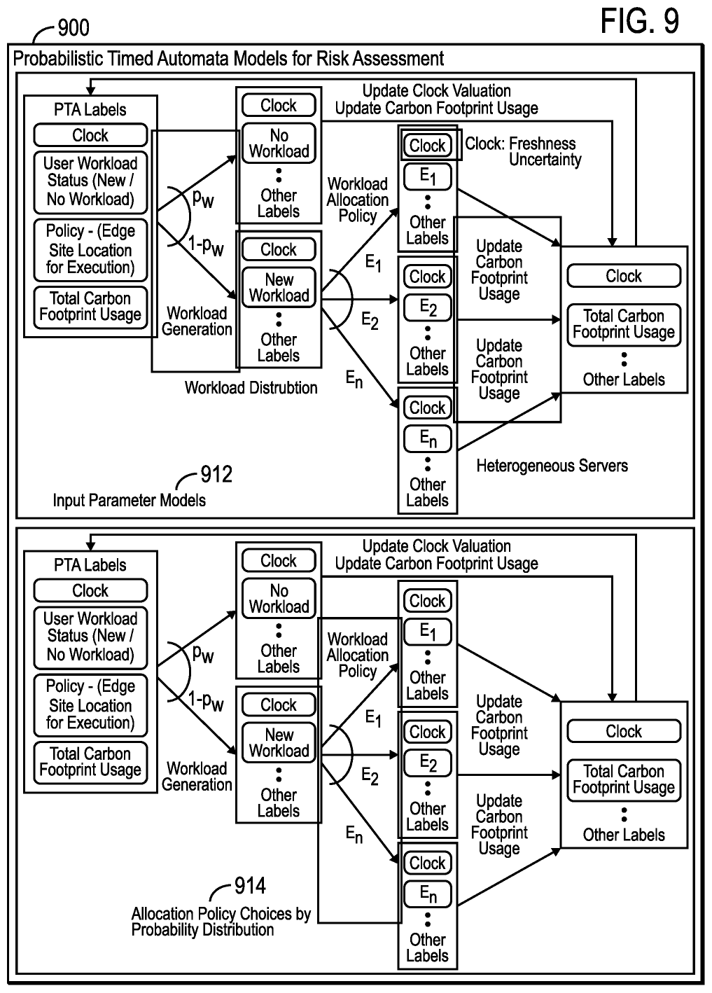

FIG. 9 illustrates a block diagram 900 that shows probabilistic time automata models for risk assessment, in accordance with certain embodiments. Various components of the system are shown in FIG. 9. The input parameters to the model 912 and the allocation policy choices by probability distribution 914 are shown in FIG. 9.

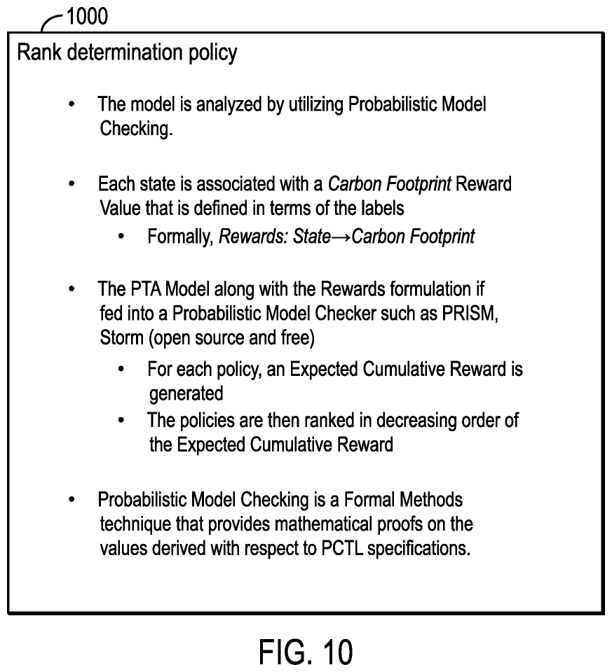

FIG. 10 illustrates a block diagram 1000 that shows policy rank determination in accordance with certain embodiments. The input parameters to the model 112 and

The model is analyzed by utilizing Probabilistic Model Checking. Each state is associated with a Carbon Footprint Reward Value that is defined in terms of the labels.

The PTA Model along with the Rewards formulation is fed into a Probabilistic Model Checker such as PRISM, Storm, etc. For each policy, an Expected Cumulative Reward is generated. The policies are then ranked in decreasing order of the Expected Cumulative Reward. Probabilistic Model Checking is a Formal Methods technique that provides mathematical proofs on the values derived with respect to Probabilistic Computation Tree Logic (PCTL) specifications and additional details may be found in the publication entitled “Stochastic model checking” by Marta Kwiatkowska, Gethin Norman, and David Parker in Formal Methods for Performance Evaluation: 7th International School on Formal Methods for the Design of Computer, Communication, and Software Systems, S F M 2007, Bertinoro, Italy, May 28-Jun. 2, 2007, Advanced Lectures 7 (2007): 220-270.

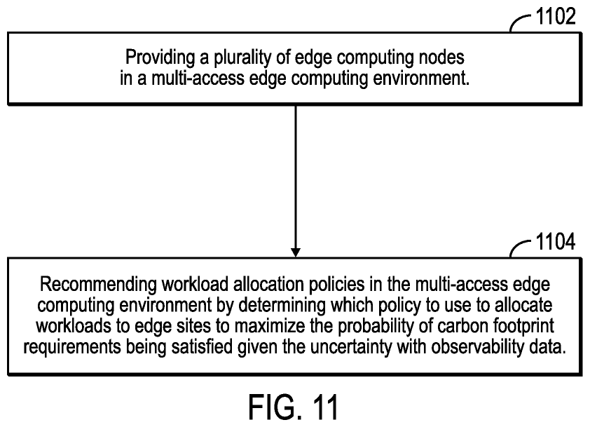

FIG. 11 illustrates a flowchart for recommendation of workload allocation policies in multi-access edge computing, in accordance with certain embodiments.

Control starts at block 1102 in which a plurality of edge computing nodes are provided in a multi-access edge computing environment. Workload allocation policies are recommended (at block 1104) in the multi-access edge computing environment by determining which policy to use to allocate workloads to edge sites to maximize the probability of carbon footprint requirements being satisfied given the uncertainty with observability data.

Therefore, FIGS. 1-11 illustrate embodiments for recommendation of workload allocation policies in multi-access edge computing.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

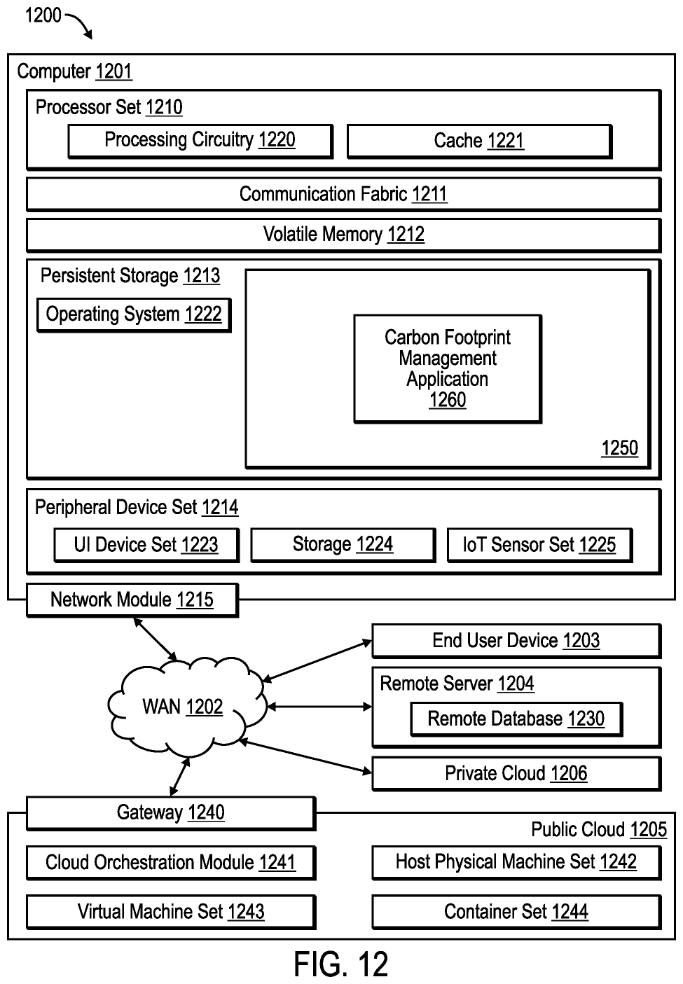

In FIG. 12, computing environment 1200 contains an example of an environment for the execution of at least some of the computer code (block 1250) involved in performing the operations of a carbon footprint management application 1260 that performs operations shown in FIGS. 1-11.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method comprising:
providing a plurality of edge computing nodes in a multi-access edge computing environment; and
recommending workload allocation policies in the multi-access edge computing environment by determining which policy to use to allocate workloads to edge sites to maximize a probability of carbon footprint requirements being satisfied given an uncertainty with observability data.

2. The method of claim 1, the method further comprising:
performing operations that act as a plugin to existing orchestration platforms for allocation policy recommendation by quantifying a risk associated with uncertainty metrics gathered from the observability data.

3. The method of claim 1, the method further comprising:
modeling workload allocation policies as Probabilistic Timed Automata.

4. The method of claim 1, the method further comprising:
modeling freshness of observability data using clocks of a Probabilistic Timed Automata.

5. The method of claim 1, wherein operations model carbon-footprint metric as labels of a Probabilistic Timed Automata and variations in user workloads as probability distributions.

6. The method of claim 1, wherein entities represent policies as probabilistic transitions determined from historical execution of policy execution logs.

7. The method of claim 1, wherein the method utilizes Probabilistic Timed Automata models with a Probabilistic Model Checker to determine a probability of an allocation policy's adherence to a carbon-footprint metric.

8. A system, comprising:
a memory; and
a processor coupled to the memory, wherein the processor performs operations, the operations comprising:
providing a plurality of edge computing nodes in a multi-access edge computing environment; and
recommending workload allocation policies in the multi-access edge computing environment by determining which policy to use to allocate workloads to edge sites to maximize a probability of carbon footprint requirements being satisfied given an uncertainty with observability data.

9. The system of claim 8, the operations further comprising:
performing additional operations that act as a plugin to existing orchestration platforms for allocation policy recommendation by quantifying a risk associated with uncertainty metrics gathered from the observability data.

10. The system of claim 8, the operations further comprising:
modeling workload allocation policies as Probabilistic Timed Automata.

11. The system of claim 8, the operations further comprising:
modeling freshness of observability data using clocks of a Probabilistic Timed Automata.

12. The system of claim 8, wherein operations model carbon-footprint metric as labels of a Probabilistic Timed Automata and variations in user workloads as probability distributions.

13. The system of claim 8, wherein entities represent policies as probabilistic transitions determined from historical execution of policy execution logs.

14. The system of claim 8, wherein the operations utilize Probabilistic Timed Automata models with a Probabilistic Model Checker to determine a probability of an allocation policy's adherence to a carbon-footprint metric.

15. A computer program product, the computer program product comprising a computer readable storage medium having computer readable program code embodied therewith, the computer readable program code when executed is configured to perform operations, the operations comprising:
providing a plurality of edge computing nodes in a multi-access edge computing environment; and
recommending workload allocation policies in the multi-access edge computing environment by determining which policy to use to allocate workloads to edge sites to maximize a probability of carbon footprint requirements being satisfied given an uncertainty with observability data.

16. The computer program product of claim 15, the operations further comprising:
performing additional operations that act as a plugin to existing orchestration platforms for allocation policy recommendation by quantifying a risk associated with uncertainty metrics gathered from the observability data.

17. The computer program product of claim 15, the operations further comprising:
modeling workload allocation policies as Probabilistic Timed Automata.

18. The computer program product of claim 15, the operations further comprising:
modeling freshness of observability data using clocks of a Probabilistic Timed Automata.

19. The computer program product of claim 15, wherein additional operations model carbon-footprint metric as labels of a Probabilistic Timed Automata and variations in user workloads as probability distributions.

20. The computer program product of claim 15, wherein entities represent policies as probabilistic transitions determined from historical execution of policy execution logs.
